(19) United States
(12) Patent Application Publication
(10) Pub. No.: US 2009/0193476 A1
(43) Pub. Date: Jul. 30, 2009

(54) Method for live transmission of content with a view to defered recovery in P2P mode after division, and control device and associated equipment

(75) Inventors: Gilles Straub, Gebusson (FR); Ali Boudani, Rennes (FR)

Correspondence Address: Thomson Licensing LLC, P.O. Box 5312, Two Independence Way, PRINCETON, NJ, 08543-5312, US

(73) Assignee: Thomson Licensing

(21) Appl. No.: 12/321,651

(22) Filed: Jan. 23, 2009

(30) Foreign Application Priority Data
Jan. 28, 2008 (EP) 0850495

(51) Int. Cl. H04N 7/173

(52) U.S. Cl. 725/87

(57) ABSTRACT

A method is dedicated to the transmission of contents to communication equipment (T1, T2) that is connected to a content broadcast network (N1) and to a communication network (N2). This method consists in i) transmitting contents live to communication equipment (T1, T2) via the broadcast network (N1), then ii) determining the communication equipment (T1, T2) having fully received and stored the contents transmitted, then iii) selecting one (T1) of these determined items of communication equipment in order to request that it divide each stored content into chunks according to a predefined rule, then to designate in each stored content first and last chunks, then iv) requesting other communication equipment (T2) having fully stored these contents to proceed to their division according to said predefined rule and taking account of the designations of their respective first and last chunks, and v) storing the identifiers of the divided contents in correspondence with the identifiers of the communication equipment (T1, T2) that divided these contents, in such a manner that these contents can be recovered from the items of communication equipment (T1, T2) in P2P mode by other communication equipment (T1′, T′3).

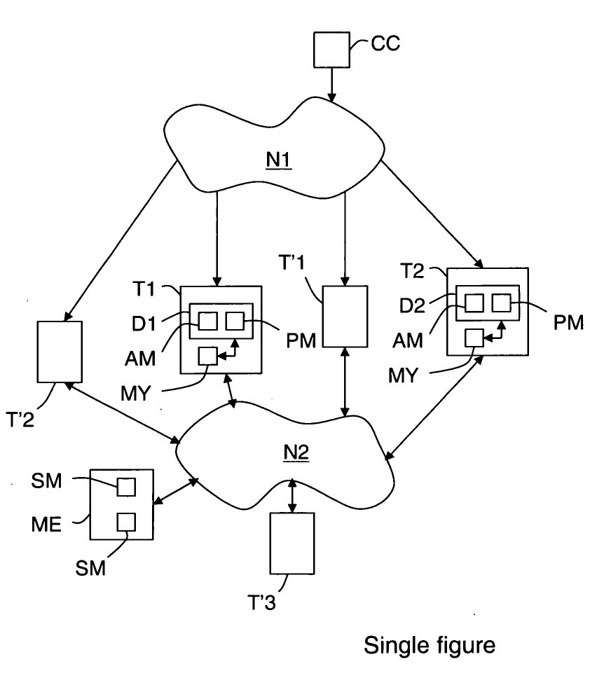

### TECHNICAL DOMAIN OF THE INVENTION

The invention relates to the streaming and live broadcast of content, possibly multimedia, to communication equipment connected to broadcast networks (or infrastructures), with a view to making available these contents broadcast for other communication equipment for a deferred use.

The invention relates to all the wired or wireless broadcast networks (or infrastructures), capable of streaming or live (or slight delay) broadcast of content (possibly multiplexed) intended for communication equipment. It can therefore relate to a wired network, such as a high or medium bitrate transmission line network, such as for example xDSL (x Digital Subscriber Line) type lines or cables or even optical fibres, or a terrestrial (for example of DVB-T, DVB-H, T-DBM or DAB type) or satellite broadcast network or again a hybrid network (that is both terrestrial (for example DVB-H) and satellite).

Moreover, “communication equipment” is understood to mean any type of communication equipment being part of, or being able to connect at least to one, a broadcast network as well as to a wired or wireless communication network. It can therefore relate, for example, to fixed or mobile (or cell) telephones, fixed or portable computers, portable digital assistant (PDAs, including “pocket PCs”), content receivers (such as for example decoders, residential gateways or STBs (Set-Top Boxes)) as long as they are equipped with communication means suitable to exchange content data packets, for example of the IP (Internet Protocol) type.

In addition, “content” is understood here to mean a set of data that defines a television or video or audio programme (radio or musical) or games or multimedia, or again an electronic file (or data).

### PRIOR ART

As persons skilled in the art know, it has been proposed to transmit content by streaming and live, via a broadcast network, possibly multiplexed on a same channel (as for example in the case of a DVB-T network), to clients having an item of communication equipment. This transmission in broadcast mode (broadcast or multicast) can be made within the framework of a video on-demand service (VOD), which consists in supplying a client with one or more sets of content that he has requested (or that are likely to interest him), or with a live programme broadcast service (for example television or music).

For example, all the contents can be transmitted to all the clients of a group so that they can be stored and each client can only use the stored content if he has paid the corresponding usage rights. It will be noted that the broadcast contents are also stored by the content provider (or the operator) in a centralised server or in distributed servers accessible via a communication network with a view to a subsequent recovery.

This method is advantageous in terms of utilisation of broadcast network resources. However, when the (communication) equipment of a client has not received at least one part of a broadcast content, it must recover this missing part from a centralised server or from the distributed servers, via a communications network, which monopolises the resources of this latter and requires several operations at its core network level. It will be understood that this type of recovery of (parts of) contents constitutes a real problem for network operators due to the constantly increasing number of clients. In addition, this method requires using one or more servers with (very) high storage capacities, so the costs are all the greater as the storage capacity is increased.

In order to improve the situation, it has been proposed to distribute the contents between the various clients of a group and to exchange in deferred mode broadcast contents selected between clients in peer-to-peer (P2P) mode. This method is described in the document “P2P proxy: peer-to-peer proxy caching scheme for VOD service”, Lee et al, Proceedings, Sixth International Conference on Computational Intelligence and Multimedia Applications, pp. 272-277, Los Alamitos, Calif., USA, 2005, IEEE Comput. Soc.

The disadvantage of this method resides in the fact that it relates only to the recovery of deferred broadcast content between clients of a same group and who therefore “know” each other. When a client who is not part of a group wants to recover deferred contents, the operation is complex and can require links to be set up with several items of communication equipment of clients of one or more groups.

In addition, there is no known method for enabling an item of communication equipment of a client to differentiate the data constituting the end of a content from the data that constitutes the following content, given that the content broadcast times are not very precise. Consequently, it is not known how to store in an item of communication equipment the entirety of a specific content coming from a continuous stream of contents, with a view to a recovery at a later time, in P2P mode, by other communication equipment.

The prior art document WO 2007/021725 discloses a multi-source and resilient video on demand streaming system for a peer-to-peer subscriber community.

The prior art document US 2003/0086023 describes a personal video recorder including a network interface.

### SUMMARY OF THE INVENTION

The purpose of the invention is therefore to improve the situation.

For this purpose, the invention first proposes a method, dedicated to the transmission of contents to communication equipment that is connected to a content broadcast network and to a communications network, and consisting in:
i) transmitting contents live to communication equipment via the broadcast network, then
ii) determining the communication equipment that has received and fully stored the contents transmitted, then
iii) selecting one of the determined items of communication equipment in order to request that it divide each stored content into chunks according to a predefined rule, then to designate in each stored content first and last chunks, then
iv) requesting other communication equipment having fully stored the transmitted contents to proceed to the division of these stored contents according to the predefined rule while taking account of the designations of their respective first and last chunks, and
v) storing the identifiers of the divided contents in correspondence with the identifiers of the communication equipment that divided these contents, in such a manner that these contents can be recovered from these items of communication equipment by other communication equipment, according to a peer-to-peer (P2P) type transmission mode.

The method according to the invention can comprise other characteristics that can be taken separately or in combination, notably:
at iii) it is possible for example to select an item of communication equipment according to at least one chosen criterion or else by choosing by lot,
at iii) the item of communication equipment selected can divide each content stored into chunks according to a predefined rule concerning the detection of at least one item of information chosen from the headers accompanying the content data,
   at iii) it is possible to detect the presence of a selected field of information and it is possible to use each information field detected to delimit two successive chunks,
      at iii), in the presence of contents transmitted according to the MPEG-2 TS format, the information field can for example be chosen from (at least) the fields PCR, PTS and EIT-PF,
at iv) each item of communication equipment having fully stored the transmitted content can delete the any chunks of a content that are located before and after the first and last chunks designated for this content,
at ii) when an item of communication equipment has fully stored the transmitted contents, it can signal this to an item of management equipment. In this case, at iii) the item of management equipment can select an item of communication equipment from the ones that informed it of the full storage of the contents, then it can request this selected item of communication equipment to divide each content stored in chunks according to the predefined rule, then designate in each stored content its first and last chunks,
   at iii) the item of management equipment can furthermore request the selected item of communication equipment to transmit to it the designations of the first and last chunks of these contents. In this case, at
      iv) the item of management equipment can transmit to the other communication equipment (that have fully stored the transmitted contents) the designations of the first and last chunks of these contents so that they proceed to divide them according to the predefined rule and taking into account the designations. At v) the item of management equipment can store the identifiers of the contents divided in correspondence with the identifiers of the communication equipment that divided these contents.

The invention also proposes a control device for an item of communication equipment, suitable to be connected to a content broadcast network and to a communication network, and comprising analysis means responsible for determining whether this item of communication equipment has received and stored all the content transmitted live via the broadcast network, and in the affirmative, to initiate the transmission, to an item of management equipment, of a message signalling the full storage of the content by the item of communication equipment.

The device according to the invention can comprise other characteristics that can be taken separately or in combination, notably:
it can comprise processing means responsible, in the case of reception of a message from the item of management equipment, designating their item of communication equipment as “master”, and requiring a division of the content stored, for dividing this content into chunks according to a predefined rule and for designating for this stored content first and last chunks, such that the divided content can be recovered by other communication equipment, according to a peer-to-peer type (P2P) transmission mode,
the processing means can be responsible for initiating the transmission to the item of management equipment of a message comprising the designations of the first and last chunks of the divided content,
the processing means can be responsible, in the case of reception of a 10 message from the item of management equipment and comprising the designations of the first and last chunks of a content previously stored, for dividing this content into chunks according to the predefined rule and taking into account the first and last chunks designated for this content, such that the divided content can be recovered by other communication equipment, according to a peer-to-peer type (P2P) transmission mode,
the processing means can be responsible for dividing each content stored into chunks according to a predefined rule concerning the detection of at least one item of information chosen from the headers accompanying the content data,
   the processing means can be responsible for detecting the presence of a chosen field of information and for using each field of information detected to delimit two successive chunks,
the processing means can be responsible for deleting, in a divided content, any chunks that are located before and after the first and last chunks designated for this content.

The invention also proposes an item of communication equipment, designed to be connected to a streaming and live broadcast network of content and to a communication network, and equipped with a control device of the type of the one described above.

The invention also proposes an item of management equipment, designed to be connected to a streaming and live broadcast network of content and/or to a communication network, and comprising selection means responsible, in the case of reception of messages signalling the full storage of a content by a set of communication equipment, for selecting one of the items of communication equipment from this set, then sending to this selected item of communication equipment a message asking it to divide the content that it has fully stored into chunks according to a predefined rule, then for designating in each content stored first and last chunks.

The item of management equipment according to the invention can comprise other characteristics that can be taken separately or in combination, notably:
its selection means can further be responsible for requiring in the message that the item of communication equipment transmits to their item of management equipment the designations of the first and last chunks of the content that it has fully stored. In this case, it can also comprise management means responsible for, in the case of reception of a message from an item of communication equipment being part of a set of equipment having fully stored a content and containing the designations of the first and last chunks of this content, for transmitting these designations to the other communication equipment of the set, such that they proceed in their turn to divide the stored content according to the predefined rule and taking into account the designations of its first and last chunks,
it can comprise storage means responsible for storing the identifiers of the divided contents in correspondence with the identifiers of the communication equipment that divided these contents, such that these contents can be recovered from the items of communication equipment by other communication equipment, according to a peer-to-peer (P2P) type transmission mode,
the selection means can be responsible for selecting an item of communication equipment according to at least one chosen criterion or else by choosing by lot.

The invention is particularly well suited, although in a non-restrictive manner, to the broadcast of content by means of a broadcast network of which the type is chosen from (at least) ADSL, DVB-T, DVB-H, T-DMB and DAB.

### BRIEF DESCRIPTION OF THE DRAWING

Other characteristics and advantages of the invention will emerge on examination of the following detailed description, and of the annexed drawing, in which the single FIGURE illustrates, in a very diagrammatic and functional manner, two items of communication equipment each equipped with a control device according to the invention and connected to a streaming and live broadcast network of contents and to a communication network, with which an item of management equipment according to the invention is also connected.

The annexed drawing can be used not only to complete the invention, but also to contribute to its definition, if necessary.

### DETAILED DESCRIPTION

The purpose of the invention is to enable communication equipment, that is connected to a streaming and live (or slightly deferred) broadcast network of contents and to a communication network, to store some at least of these contents broadcast in their entirety so that they can be recovered in deferred mode by other communication equipment, that is connected either to the broadcast network and to the to the communication network, or only to the communication network.

The contents can for example be broadcast in streaming mode and live within the framework of a video on demand (VOD) service or a programme broadcast service (for example television or radio or even music) or files (or data).

It is important to note that the broadcast network and the communication network can take each other's place. In this case, the communication network also provides the broadcast of the content.

In the following, it is considered, as a non-restrictive example, that the broadcast network (N1) is of the DVB-T type. But, the invention is not restricted to this type of broadcast network. Indeed, it relates to any type of broadcast network (or infrastructure), wired or wireless, capable of streaming and live broadcasting of the contents (possibly multiplexed) intended for communication equipment. It can therefore be a wired network, such as a high or medium bitrate transmission line network, such as for example xDSL type lines or cables or even optical fibres, or a terrestrial (for example of DVB-T, DVB-H, T-DBM or DAB type) or satellite broadcast network or again a hybrid network.

Moreover, it is considered in what follows, as a non-restrictive example, that the communication network (N2) is a wired network (for example of the ADSL type) providing an IP access. But, the invention is not limited to this kind of communication network. Indeed, it relates to any kind of communication network capable of transmitting, through wires or through waves, contents data packets (possibly of the IP type). It can therefore also relate to a wired network with cables or optical fibres, or a wireless network, possibly of the mobile or cell type.

Taking into account the illustrative choices made above, it is considered in what follows, as a non-restrictive example, that the communication equipment (Ti) of the clients are content receivers of the STB (Set-Top Box) type. But, the invention is not limited to this kind of communication equipment. Indeed, it relates to any type of communication equipment capable of receiving content, particularly in streaming mode and live, from a broadcast network and of exchanging content data packets, through wires or through waves, notably according to a peer-to-peer mode, with other communication equipment or network equipment via a communication network. It can therefore also relate to a fixed or mobile (or cell) telephone, a fixed or portable computer, a portable digital assistant (PDA), or a content receiver (such as for example a decoder or a residential gateway).

On the single FIGURE, two types of communication equipment Ti (i=1 or 2) and T′j (j=1 to 3) have been shown. The first type (Ti) contains communication equipment that is equipped with a device Di according to the invention and that is connected to the broadcast network N1 and to the communication network N2. The second type (T′j) contains communication equipment that is not equipped with a device Di according to the invention but that is connected either to the broadcast network N1 and to the communication network N2 (they can then classically receive content live for their personal use and recover full contents from item(s) of communication equipment of the first type Ti), or only to the communication network N2 (they can then only recover full content from item(s) of communication equipment of the first type Ti).

It will be noted that the indices i and j can take any value greater than or equal to 1.

Finally, it is considered in what follows, as a non-restrictive example, that the broadcast contents are television programmes (video). But, the invention is not limited to this type of content: It relates indeed to any type of content constituted by a set of data being able to be broadcast in the form of data packets (possibly multiplexed). It can therefore also relate to audio contents, as for example audio programmes (radio or music), games, multimedia content, or even electronic files (or “data”).

The invention proposes a method comprising five main steps.

A first main step (i) consists in transmitting content live and in streaming mode to communication equipment of the first type Ti via the broadcast network N1.

As illustrated, the content is for example from a content server CS that is connected to the broadcast network N1. But, they can be from several content servers.

Some communication equipment of the first type Ti store (save), for example in a memory MY (or any equivalent storage means), some contents broadcast live that the content provider allows to be recovered in deferred mode in P2P mode. To achieve this, they are programmed according to sets of information that define the contents, for example within an electronic program guide (EPG) or a service information table.

It is recalled that an EPG is a file that is generated by a content provider (such as television programmes) and that is regularly transmitted to the communication equipment Ti and T′j, particularly via the broadcast network N1 before the start of the transmission of the contents that it defines. An EPG comprises notably for each content (here a television programme) a summary, fields defining its type, its broadcast duration and the start and end times of its live broadcast, as well as possibly an indication signalling that its can be recovered in deferred mode in P2P mode. The recording of a content thus generally begins a few moments (for example a few minutes) before the theoretical start of broadcast of this content that is indicated in the EPG and generally finishes a few moments (for example a few minutes) after the theoretical end of broadcast of this content that is indicated in the EPG.

A second main step (ii) of the method consists in determining the communication equipment of the first type Ti that fully received and stored the contents transmitted by broadcast via the broadcast network N1.

This second main step (ii) can for example be performed at the initiative of the communication equipment of the first type Ti, and more specifically of the control device Di that they comprise (as illustrated) or to which they are coupled.

A control device Di, according to the invention, comprises an analysis module AM that is first responsible for determining whether its communication equipment of the first type Ti has received (and stored) the entirety of a content that was transmitted live via the broadcast network N1. To achieve this, it can for example observe the data of the contents that are stored in the storage means MY of its communication equipment of the first type Ti, to verify whether the start and end times of the storage of a content corresponding to the start and end times of broadcast of a content that are indicated in the EPG.

In the affirmative (and therefore if such a content was stored), the analysis module AM initiates the transmission to an item of management equipment ME, according to the invention, of a message signalling the full storage of a content designated by its communication equipment of the first type Ti.

This item of management equipment ME can be accessed via the broadcast network N1 and/or via the communication network N2 (as shown in a non-restrictive manner on the single FIGURE).

An item of management equipment ME is notably responsible for receiving the messages that are transmitted by the communication equipment of the first type Ti and that signal the full storage of a designated content. On reception of such a message, it can for example (pre-)store the communication identifier of the communication equipment of the first type Ti that transmitted it in correspondence with the identifier of the content that it designates.

By means of this information mechanism, the item management equipment ME very rapidly determines after the broadcast of a content the communication equipment of the first type Ti that effectively integrally (or fully) stored it in their storage means MY. This communication equipment of the first type Ti thus forms a set associated with (at least) a broadcast content.

A third main step (iii) of the method consists in selecting one of the items of communication equipment of the first type Ti that is part of a set associated with (at least) a broadcast content in order to request it to divide this received content into chunks (or “chunks”) according to a predefined rule, then to designate, in each received content, first and last chunks (or chunks).

It will be understood that this selection is preferentially made in the management equipment ME. In this case, the item of management equipment ME comprises a selection module SM that is notably responsible for selecting one of the items of communication equipment of the first type Ti of a set associated with (at least) a broadcast content and constituted from received messages, as indicated above. This selected equipment, for example T1, is for example called “master” for (at least) a broadcast content.

Any type of selection can be envisaged, and notably a selection according to at least one criterion (covering for example on the available bandwidth or the bitrate or again the storage capacities) or by choosing by lot (random).

Once the selection module SM has selected a master equipment for (at least) a broadcast content, it sends it a message requesting it to divide the content(s) that it has fully stored into chunks according to the predefined rule, then to designate, in each content stored, first and last chunks.

On reception of such a message, the master equipment T1 transmits it to its control device D1. This latter (D1) comprises a processing module PM responsible, when its item of equipment T1 has been designated as master for (at least) a broadcast content designated in a message, for extracting from the storage means MY of its master equipment T1 each designated content in order to divide it into chunks according to the predefined rule and to designate for it first and last chunks.

Any type of rule can be envisaged, and notably a rule concerning the detection of at least one information chosen from the headers of the transport layer that accompanies the data (useful) of the contents when they are transmitted in the form of packets, for example IP (Internet Protocol). This solution guarantees an independence with respect to the securing mechanism (or DRM, for Digital Rights management) that is applied to the content. For example, the processing module PM can analyse the stored contents in order to detect the presence of a chosen field of information. For example, when the contents are transmitted according to the MPEG-2 TS format (Transport Stream), the processing module PM can notably search the TS headers for the field of information called PCR (Program Clock Delivery—field used for resynchronisation) or PTS (Presentation Time Stamp—field used to signal a time information).

It is recalled that, according to the DVB standard (Digital Video Broadcasting—standard for broadcasting videos in digital form), a PCR field is placed in front of each picture of a video, namely a PCR field every 40 ms and therefore per TS packet.

Each field of information detected (for example in a TS header) can then be used to delimit two successive chunks, and thus enable the division of a stored content.

Once the processing module PM has divided a content into chunks, it chooses one of them as first chunk (or content start chunk) and another of them as last chunk (or content end chunk). This double choice, (start and end of a content) can for example be made by means of an item of information that is contained in the EPG (or similar). As a variant, this double choice (start and end of a content) can for example be made by using the information that is transmitted at the start of each “event” (that constitutes notably a content) in a field of information, as for example the field EIT—PF (Present/Following) that is moreover contained in the information table on the contents called EIT (Event Information Table), which is transmitted to the users before the transmission of the contents.

The divided content is then stored again, for example in the storage means SM of the master equipment T1, or else in other storage means of this latter, such that it can be recovered subsequently by other communication equipment of the first type Ti′ (i≠i) or of the second type T′j, according to a peer-to-peer type (P2P) transmission mode.

It will be noted that before the processing module PM proceeds to the final storage of a divided content, it can possibly delete the any chunks that are located before and after the first and last chunks that it has chosen for this divided content.

A fourth main step (iv) of the method consists in requesting the other communication equipment of the first type Ti (for example T2), that are part of the same set as the master equipment T1 that has just divided a (at least one) content, to proceed in their turn to the division of this content or contents that they store according to the predefined rule (used by the master equipment T1) and taking account of the designations of their first and last chunks (respective).

A designation of first and last chunks can for example consist in the supply of the data that constitute the start and end of a content (for example is first and last pictures in the case of a video). But, it can also relate to information that designates, in the EPG, the first and last pictures of a content. In the last case, a comparison between the last pictures of the preceding content and the first pictures of the designated content makes it possible to determine the first picture of the designated content and a comparison between the last pictures of the designated content and the first pictures of the content that follows it makes it possible to determine the last picture of the designated content.

The designations of the first and last chunks of a content can for example be transmitted directly by the master equipment T1 to the other communication equipment of the first type (T2) of its set. But, this imposes that it knows the communication addresses (or at least the identifiers) of these other items of communication equipment of the first type (T2). These addresses (or identifiers) can for example be sent to it by the management equipment ME at the same time as the message that designates it as master, or naturally on request and therefore at its initiative.

But, in an advantageous variant, the designations of the first and last chunks of a content can for example first be transmitted by the master equipment T1 to the management equipment ME, by means of a dedicated message and at the initiative of the processing module PM of its control device D1.

In this case, the management equipment ME comprises a management module MM responsible, when it receives a dedicated message from a master equipment T1 being part of a set associated with (at least) a content and containing the designations of the first and last chunks of this content, for determining the communication addresses (or at least the identifiers) of the other communication equipment of the first type (T2) of this set (previously stored by its management equipment ME) in order to transmits to each of these other items of communication equipment of the first type (T2) a message containing the descriptions of the first and last chunks received.

Then, when the other items of communication equipment of the first type (T2) receive these messages, they communicate them to their respective control devices (D2). The processing module PM of each control device (D2) then extracts, from the storage means MY of its communication equipment of the first type (T2), each content designated in the received message to divide it into chunks according to the predefined rule (used by the master equipment T1) and taking into account the designations of its first and last chunks contained in the received message.

Then, the processing module PM of each control device (D2) stores again each divided content, for example in the storage means MY of its communication equipment of the first type (T2), or else in other storage means of this latter, such that it can be recovered subsequently by other communication equipment of the first type Ti′ (i≠i) or of the second type T′j, according to a peer-to-peer type (P2P) transmission mode. As indicated above, before a processing module PM proceeds to the final storage of a divided content, it can possibly delete the any chunks that are located before and after the first and last chunks that it has chosen for this divided content.

A fifth main step (v) of the method consists in storing the identifiers of the contents divided in correspondence with the identifiers of the communication equipment of the first type Ti that has divided this content. This storage can for example be made in the storage means SM of the management equipment ME. This storage means SM can be presented in any form, such as for example a memory or a database.

For example, the management equipment ME can store and update in its storage means SM a table in which is indicated, for each content broadcast and being able to be recovered in deferred mode, the list of communication addresses (or at least the identifiers) of the communication equipment of the first type Ti that stores it fully. Such a table can be communicated (for example periodically) by the management equipment ME to the communication equipment of the first type Ti and of the second type T′j whose users are clients, in order that they can recover the content(s) that interest their users from the communication equipment of the first type Ti that stores it(them), according to a peer-to-peer type (P2P) transmission mode.

It will be noted that each item of communication equipment of the first type Ti can possibly apply its own policy with regard to storage time of integrated content divided with a view to a deferred recovery. In other words, it can for example store a divided content only for a predefined duration.

It will also be noted that each item of equipment of the first type Ti can possibly be arranged in such a manner as to delete the chosen chunks that are located between the first and last chunks of a content that it has divided, after having assigned identifiers to each of the chunks of the full divided content. Hence, it only stores the contents that interest its user, while offering other equipment the possibility to recover the portions of content that it has conserved in its storage means after the deletion operation.

It will also be noted that when the number of items of (communication) equipment of the first type Ti that store a same full content (divided) is low, the management equipment ME can possibly be arranged in such a manner as to request one or more other items of communication equipment of the first type Ti′ to go and recover this full content from one of the items of communication equipment of the first type Ti that store it, in order to store it itself and thus to make it available for other items of equipment of the first type Ti′ or of the second type T′j. In this case, the communication address (or at least an identifier) of each new item of equipment of the first type Ti′, that stores a 10 content already divided, recovered, is added in correspondence with the identifier of this content in the table stored in the storage means SM of the management equipment ME.

It will be noted that a control device Di, according to the invention, is preferentially realized in the form of software modules. But, it can also be realized in the form of electronic circuits (hardware) or of a combination of software modules and hardware.

Likewise, the selection module SM, as well as possibly the storage means SM, of the management equipment ME, are preferably realized in the form of software modules. But, it or they can also be realized in the form of hardware or of a combination of software modules and hardware.

The invention is not restricted to the embodiments of control device, communication equipment, management equipment and transmission method described above, only as an example, but its covers all the variants that those skilled in the art will be able to envisage within the framework of the following claims.

1. Method for transmitting contents to communication equipment connected to a content broadcast network and to a communication network (R2), consisting in i) transmitting contents live to communication equipment via said broadcast network, then ii) determining the communication equipment having fully received and stored said contents transmitted, then iii) selecting one of the determined items of communication equipment in order to request that it divide each stored content into chunks according to a predefined rule, then to designate in each stored content first and last chunks, then iv) requesting other communication equipment having fully stored said transmitted contents to proceed to the division of these stored contents according to said predefined rule while taking account of the designations of their respective first and last chunks, and v) storing the identifiers of the divided contents in correspondence with the identifiers of said communication equipment that divided these contents, in such a manner that these contents can be recovered from said items of communication equipment by other communication equipment, according to a peer-to-peer type transmission mode.

2. Method according to claim 1, wherein at iii) an item of communication equipment is selected according to at least one chosen criterion.

3. Method according to claim 1, wherein at iii) an item of communication equipment is selected by choosing by lot.

4. Method according to one of claim 1, wherein at iii) said item of communication equipment selected divides each content stored into chunks according to a predefined rule concerning the detection of at least one item of information chosen from the headers accompanying said content data.

5. Method according to claim 4, wherein at iii) the presence of a selected field of information is detected and each information field detected is used to delimit two successive chunks.

6. Method according to claim 5, wherein at iii), in the presence of contents transmitted according to the MPEG-2 TS format, said field of information is chosen from at least the fields PCR, PTS and EIT-PF.

7. Method according to one of claim 1, wherein each item of communication equipment having fully stored said transmitted content deletes the any chunks of a content that are located before and after the first and last chunks designated for this content.

8. Method according to one of claim 1, wherein at ii) when an item of communication equipment has fully stored said transmitted contents, it signals this to an item of management equipment, and wherein at iii) said item of management equipment selects an item of communication equipment from the ones that informed it of the full storage of said contents, then it requests this selected item of communication equipment to divide each content stored in chunks according to said predefined rule, then to designate in each stored content its first and last chunks.

9. Method according to claim 8, wherein at iii) said item of management equipment furthermore requests said selected item of communication equipment to transmit to it said designations of the first and last chunks of these contents, and wherein at iv) said item of management equipment transmits to said other communication equipment, that have fully stored said transmitted contents, said designations of the first and last chunks of these contents so that they proceed to divide them according to said predefined rule and taking into account the designations, and wherein at v) said item of management equipment stores the identifiers of the contents divided in correspondence with the identifiers of said communication equipment that divided these contents.

10. Control device for an item of communication equipment suitable to be connected to a content broadcast network and to a communication network, comprising analysis means arranged to determine whether said item of communication equipment has received and stored all a content transmitted live via said broadcast network, and in the affirmative to initiate the transmission to an item of management equipment of a message signalling the full storage of said content by said item of communication equipment.

11. Device according to claim 10, comprising processing means arranged, in the case of reception of a message from said item of management equipment, designating said item of communication equipment as “master”, and requiring a division of said content stored, for dividing this content into chunks according to a predefined rule and for designating for said stored content first and last chunks, such that said divided content can be recovered by other communication equipment, according to a peer-to-peer type transmission mode.

12. Device according to claim 11, wherein said processing means are arranged to initiate the transmission to said item of management equipment of a message comprising the designations of the first and last chunks of the divided content.

13. Device according to claim 11, wherein said processing means are arranged, in the case of reception of a message from said item of management equipment and comprising the designations of the first and last chunks of a content previously stored, for dividing this content into chunks according to said predefined rule and taking into account said first and last chunks designated for this content, such that said divided content can be recovered by other communication equipment, according to a peer-to-peer type transmission mode.

14. Device according to one of claim 11, wherein said processing means are arranged to divide each content stored into chunks according to a predefined rule concerning the detection of at least one item of information chosen from the headers accompanying said content data.

15. Device according to claim 14, wherein said processing means are arranged to detect the presence of a selected field of information and to use each information field detected to delimit two successive chunks.

16. Device according to claim 15, wherein in the presence of contents transmitted according to the MPEG-2 TS format, said field of information is chosen from at least the fields PCR, PTS and EIT-PF.

17. Device according to one of claim 11, wherein said processing means are arranged to delete, in a divided content, any chunks that are located before and after the first and last chunks designated for this content.

18. Communication equipment, suitable to be connected to a content broadcast network and to a communication network, comprising a control device according to one of claim 10.

19. Management equipment for a content broadcast network and/or a communication network to which communication equipment is connected according to claim 18, comprising selection means arranged, in the case of reception of messages signalling the full storage of a content by a set of communication equipment, to select one of the items of communication equipment from this set, then send to this selected item of communication equipment a message asking it to divide the content that it has fully stored into chunks according to a predefined rule, then designate in each content stored first and last chunks.

20. Equipment according to claim 19, wherein said selection means are further arranged to require in said message that said item of communication equipment transmits to said item of management equipment the designations of the first and last chunks of the content that it has fully stored, and comprising management means arranged, in the case of reception of a message from an item of communication equipment being part of a set of equipment having fully stored a content and containing the designations of the first and last chunks of said content, to transmit these designations to the other communication equipment of said set, such that they proceed in their turn to divide the stored content according to said predefined rule and taking into account the designations of its first and last chunks.

21. Equipment according to one of claim 19, comprising storage means suitable to store the identifiers of the divided contents in correspondence with the identifiers of the communication equipment that divided these contents, such that these contents can be recovered from said items of communication equipment by other communication equipment, according to a peer-to-peer type transmission mode,

22. Equipment according to one of claim 19, wherein said selection means are arranged to select an item of communication equipment according to at least one chosen criterion.

23. Equipment according to one of claim 19, wherein said selection means are arranged to select an item of communication equipment by choosing by lot.

24. Use of the control device, the communication equipment, the management equipment and the transmission method according to one of the aforementioned claims in the case of a broadcast network of a type chosen from a group comprising at least ADSL, DVB-T, DVB-H, T-DMB and DAB.
